(19) United States
(12) Patent Application Publication
(10) Pub. No.: US 2015/0123470 A1
(43) Pub. Date: May 7, 2015

(54) ELECTRICAL EQUIPMENT POWER MANAGER FOR VEHICLE BATTERY PROTECTION

(71) Applicant: 911 Circuits LLC, Keizer, OR (US)

(72) Inventors: John Allan Moore, Keizer, OR (US); Benjamin Fedorenko, Salem, OR (US)

(21) Appl. No.: 14/532,899

(22) Filed: Nov. 4, 2014

Related U.S. Application Data
(60) Provisional application No. 61/899,668, filed on Nov. 4, 2013.

(51) Int. Cl. B60L 11/18

(52) U.S. Cl. CPC B60L 11/1861
USPC 307/10.1

(57) ABSTRACT

A system for controlling electrical demands on a vehicle battery in a vehicle is provided. The system includes a power conduit adapted to be coupled between the vehicle battery and one or more pieces of aftermarket electrical equipment deployed within a vehicle having electrical systems powered by the vehicle battery and a power manager. The power manager includes a timer circuit operatively coupled with the power conduit and a hardware selector operable by a user for controlling a timer value of the timer circuit, the system being operative to shut off delivery of electrical power through the power conduit to selected aftermarket electrical equipment in response to an elapsed time exceeding the timer value of the timer circuit.

### CROSS REFERENCE TO RELATED APPLICATION

This application claims priority to U.S. provisional patent application, Ser. No. 61/899,668, entitled “ELECTRICAL EQUIPMENT POWER MANAGER FOR VEHICLE BATTERY PROTECTION” filed on Nov. 4, 2013, the entire disclosure of which is herein incorporated by reference.

### BACKGROUND

Vehicle batteries are used to supply power to a wide range of electrical equipment installed in or otherwise used with the vehicle. While the vehicle is running, the electrical equipment is powered by an alternator or otherwise such that electrical equipment does not drain the battery. When the vehicle is turned off, the battery itself may supply power to any electrical equipment that is not shut off. This can eventually drain the battery to a point where it is not able to start the vehicle.

### SUMMARY

A system for controlling electrical demands on a vehicle battery in a vehicle is provided. The system includes a power conduit adapted to be coupled between the vehicle battery and one or more pieces of aftermarket electrical equipment deployed within a vehicle having electrical systems powered by the vehicle battery and a power manager. The power manager includes a timer circuit operatively coupled with the power conduit and a hardware selector operable by a user for controlling a timer value of the timer circuit, the system being operative to shut off delivery of electrical power through the power conduit to selected aftermarket electrical equipment in response to an elapsed time exceeding the timer value of the timer circuit. In this way, power to the selected electrical equipment may be shut off to protect the vehicle battery from being drained by the electrical equipment. Consequently, the likelihood of the vehicle being unable to start due to a low battery charge or perform other desirable functions needing electrical power is drastically reduced, thereby improving vehicle operation.

### BRIEF DESCRIPTION OF THE DRAWINGS

FIG. 1 is a schematic depiction of a system for controlling electrical demand on a vehicle battery in a vehicle;

FIG. 2 is a method for operating software utility connected to a system configured to control electrical demands on a vehicle battery;

FIG. 3 is a flow chart depicting a method for using a power manager to protect a vehicle battery from excessive draining after the vehicle is turned off;

FIGS. 4 and 5 depict a form factor of a device that implements, among other things, the power management features of FIG. 1;

FIG. 6 depicts a user interface for programming the operation of the power management features of the device of FIGS. 4 and 5; and

FIGS. 7 and 8 depict alternate form factors of devices that implement, among other things, the power management features of FIGS. 1-3, and that may be programmed via the user interface of FIG. 6.

### DETAILED DESCRIPTION

A wide variety of electrical equipment may be connected to the electrical systems of a vehicle. Further, this equipment may be installed such that it can be powered by the vehicle battery when the vehicle is turned off. For example, a law enforcement vehicle may include aftermarket or add-on equipment such as radios, light bars, scanners, radar, device chargers, laptops, etc. This equipment can be left on after the vehicle is turned off for a variety of reasons. The law enforcement officer might intentionally leave equipment turned on during a traffic stop, while spending time in the precinct, etc. Taking a laptop computer as an example, the officer might want to leave the laptop on even when leaving the vehicle for a significant period of time, in order to avoid having to restart and re-login to the computer.

The present description contemplates a power manager having timers and other mechanisms that protect the vehicle battery from being drained by connected electrical equipment. The protection mechanisms are triggered to operate when the vehicle is turned off. Various methods may be used to determine that the vehicle has been turned off. In one example, the power manager is connected directly to the vehicle ignition, and can therefore easily sense that the vehicle has been turned off. If a direct connection to the ignition is not used, various other electrical conditions may be monitored to make the determination. For example, if an expected sine wave from the alternator, consistent with engine operation, is absent for a period of time, the power manager can determine that the vehicle has turned off. These are but examples of detecting that the vehicle has been turned off, other methods may be used.

In response to determining that the vehicle has been turned off, the power manager may initiate countdown of one or more countdown timers. Each countdown timer is associated with one or more pieces of electrical equipment. Upon expiration of the timer, the associated pieces of electrical equipment are turned off to reduce the load on the battery. In this way, power can be managed in the vehicle to decrease the likelihood of a state of charge of the battery falling below a desired value. In some cases it will be desirable to have more than one timer. Multiple timer circuits would allow some equipment to be powered off after a first interval, with other equipment remaining powered until a later interval expires. For instance, a laptop installed in an emergency vehicle might require a lengthy start up sequence. To avoid the inconvenience of having to repeatedly go through such a lengthy sequence, the laptop might be placed on a circuit with a longer timeout than that used for other equipment, such as flashlight and cell phone chargers. The length of time before the countdown timers expire may be configured in various ways, examples of which are described below.

In addition to the timer protections described above, the power manager can monitor voltage or other electrical conditions at or affecting the battery and take various actions when the battery is at risk of being drained below a minimal level needed to restart the vehicle. One monitoring method includes the power manager sensing the battery voltage to determine the voltage has dropped to an under-voltage warning threshold value. For example, in a 12V battery, the under-voltage warning threshold might be 11.5V. If the measured voltage falls below this warning threshold, the power manager can provide a warning indication. The indication can include a blinking light, audible tone, or other signal to alert the driver to the battery status. This type of alert provides a warning to the driver, enabling the driver to take actions to increase battery charge and/or reduce power consumption in the vehicle.

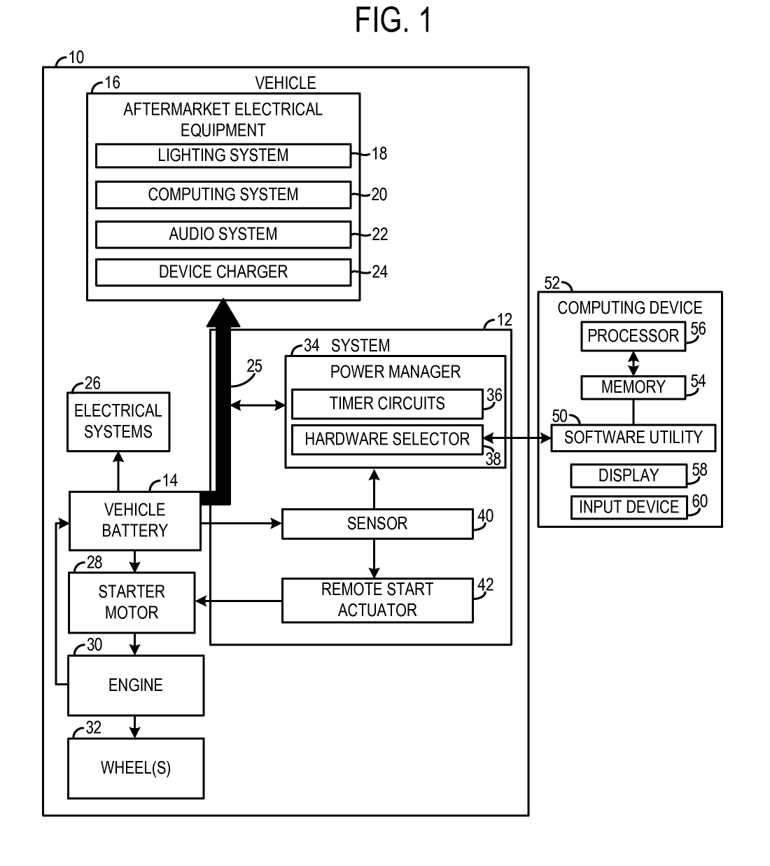

Furthermore, if the measured voltage falls below an under-voltage shut down threshold value, the power manager may turn off some or all of the connected equipment immediately in order to prevent further draining of the battery. With a 12V battery, this might be configured to occur at 11V. Instead of shutting down all of the connected equipment, a remote start signal can be sent. This triggers vehicle ignition to start the vehicle such that the alternator can begin recharging the battery. Remote start capability may be enabled or disabled by the user as described below with reference to FIG. 1.

Additionally, the power manager can monitor electrical conditions to sense an over-voltage shut down threshold. If the measured voltage exceeds the over-voltage shut down threshold, the system can shut down one or more pieces of the electrical equipment to protect them from being damaged.

Turning now to the figures, FIG. 1 shows a schematic depiction of a vehicle 10 including a system 12 for controlling electrical demand on a vehicle battery 14 in the vehicle. The vehicle 10 includes one or more pieces of aftermarket electrical equipment 16. In other words, the vehicle has one or more pieces of electrical equipment deployed therein. In the depicted example, the pieces of aftermarket electrical equipment includes a lighting system 18, a computing system 20, an audio system 22 (e.g., a radio, sirens, etc.), and a device charger 24. However, other types, combinations, etc., of electrical equipment have contemplated. Thus, in another example the aftermarket electrical equipment may include one or more of the aforementioned systems. The vehicle battery 14 provides power to the pieces of aftermarket electrical equipment via a power conduit 25. Thus, the power conduit 25 is adapted to be coupled between the vehicle battery 14 and the pieces of aftermarket electrical equipment.

The power conduit 25 may include one or more sections coupling the battery to each individual piece of aftermarket equipment, in one example.

The vehicle 10 also may include electrical systems 26 receiving electrical power from the vehicle battery 14 such as dashboard interface, stereo, powered windows, wiper blade system, etc. The vehicle battery 14 may also provide power to a starter motor 28 configured to initiate combustion operation in an engine 30. It will be appreciated that the engine 30 may include components for implementing combustion operation which are not depicted, such as one or more cylinders, intake and exhaust valves, an intake system, exhaust system, etc.

The engine 30 is configured to provide motive power to one or more wheels 32 in the vehicle 10. It will be appreciated that a transmission (not shown) may be provided in the vehicle to enable the aforementioned motive power transfer. Additionally or alternatively the vehicle 10 may include a motor (not shown). The motor may be configured to provide motive power to one or more wheels in the vehicle. Therefore, hybrid vehicle systems have been contemplated, such as series or parallel hybrid systems. The engine 30 may also be configured to provide charge to the vehicle battery 14, when performing combustion operation. Therefore, the engine 30 may include an alternator which provides power to the vehicle battery 14.

The system 12 may include a power manager 34 for managing power distribution to the aftermarket electrical equipment 16. The power manager 34 includes a plurality of timer circuits 36. Each of the timer circuits 26 are operatively coupled with the power conduit 25 and may be associated with a different piece of aftermarket electrical equipment. The system 12 further includes a hardware selector 38 operable by a user for controlling a timer value of each of the timer circuits 36. It will be appreciated that the timer values of each of the circuits may vary. That is to say, that the timer value of a first timer circuit may be different from a timer value of a second timer circuit. In one example, the hardware selector 38 may be a DIP switch panel. The DIP switch panel may include one or more DIP switches. Specifically in one example, the number of DIP switches in the DIP switch panel may be equivalent to the number of timer circuits in the system 12. Further in one example, the DIP switch panel may be configured to implement a binary encoding to enable user selection of the timer values of the timer circuits. Using a DIP switch panel as the hardware selector enables the cost of the system to be decreased when compared to other types of selectors. Moreover, using DIP switches may increase the reliability of the system.

The system 12 and specifically the power manager 34 may be operative to shut off delivery of electrical power through the power conduit to selected aftermarket electrical equipment in response to an elapsed time exceeding a timer value of a corresponding timer circuit. In this way, power consumption in the vehicle is reduced, thereby reducing battery drain. As a result, the likelihood of the vehicle battery dropping below a threshold state of charge associated with starting the vehicle and/or performing other essential operations in the vehicle is drastically reduced.

The system 12 may further include a sensor 40 for detecting a state of charge of the vehicle battery 14. Thus, the sensor 40 may be coupled to the vehicle battery 14. The system 12 may further includes a remote start actuator 42 receiving a signal from the sensor and operable to cause a remote start of the vehicle in response to the battery state of charge, determined by the sensor 40, falling below a charge threshold. In such an example, the charge threshold may be programmable. The remote start may be implemented by the starter motor 28, in one example. However, the remote start may be implemented via another device, in other examples. Additionally in one example, the power manager 34 may be configured to receive a signal from the sensor 40 and turn off one or more of the pieces of aftermarket electrical equipment if the state of charge of the battery falls below a threshold value. In one example, the threshold value may be programmable.

A software utility 50 executed on a computing device 52 may be used to configure timer value ranges that can be selected using the hardware selector 38. Thus, the software utility may be in electronic communication with the hardware selector. Additionally, the software utility may be used to configure the threshold value of the state of charge of the vehicle battery used to determine when to turn off the aftermarket electrical equipment. Furthermore, the software utility may be used to configure the charge threshold related to the remote starting of the vehicle. As shown, the computing device 52 includes the software utility 50 stored in memory 54 executable by a processor 56. The software utility 50 enables a user to customize various ranges and threshold used in power manager, thereby increasing the system's adaptability. The computing device 52 may also include a display 58 for presenting a user interface corresponding to the software utility. Additionally, the computing device 52 may include an input device 60, such as a keyboard, mouse, touch interface, etc.

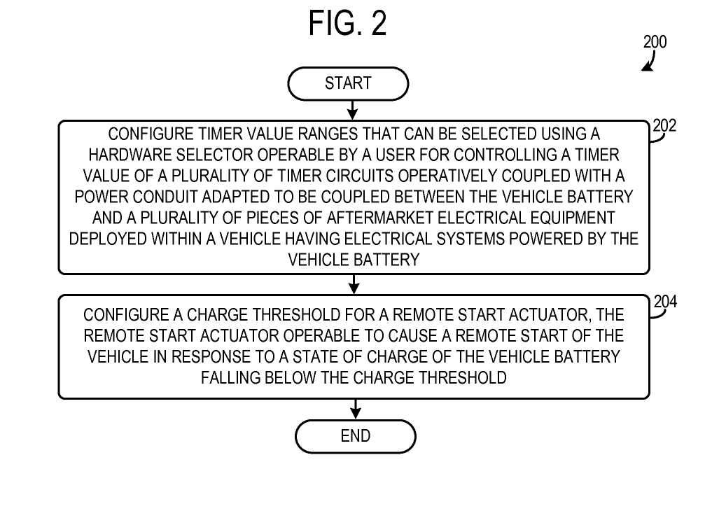

FIG. 2 shows a method 200 for operating a software utility connected to a system configured to control electrical demands on a vehicle battery. The method 200 may be implemented via the vehicle 10 and system 12 discussed above with regard to FIG. 1 or may be implemented by other suitable vehicles and systems.

At 202 the method includes configuring timer value ranges that can be selected using a hardware selector operable by a user for controlling a timer value of a plurality of timer circuits operatively coupled with a power conduit adapted to be coupled between the vehicle battery and a plurality of pieces of aftermarket electrical equipment deployed within a vehicle having electrical systems powered by the vehicle battery. In one example, the timer value ranges may not be equivalent. Further in one example, the plurality of timer circuits are a DIP switch panel including a plurality of DIP switches.

Next at 204 the method includes configuring a charge threshold for a remote start actuator, the remote start actuator operable to cause a remote start of the vehicle in response to a state of charge of the vehicle battery falling below the charge threshold. The method 200 enables a user to customize the timer value ranges and charge threshold used by the power manager.

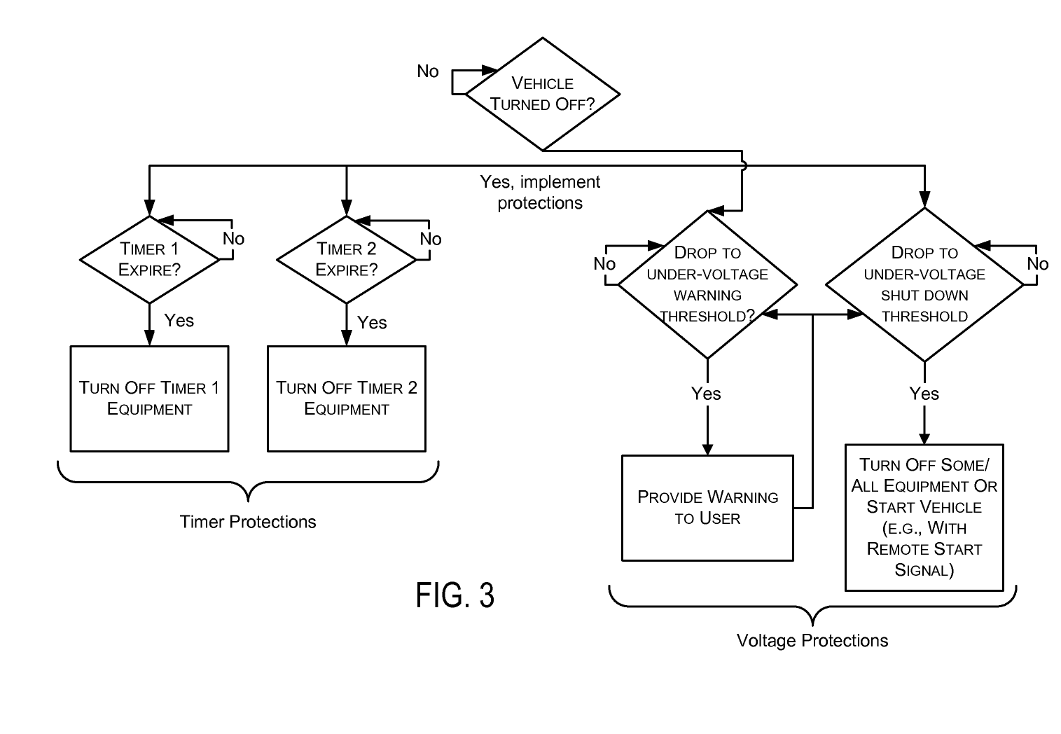

FIG. 3 shows a method for protecting a battery using two shutdown timers in addition to monitoring battery voltage conditions. As indicated in the figure, the protections are triggered to operate upon sensing that the vehicle has been turned off. Referring to the timers, when the first timer expires, the power manager turns off all of the equipment powered through the circuits connected to the timer. A second timer is shown with similar functionality. The current system includes two timers, but such a system may include a single timer or three or more timers, each configured to turn off associated equipment at different times.

Voltage protections as described above are shown on the right hand side of the figure. One protection is the under-voltage warning threshold, as described above. Specifically, if the monitored battery voltage drops to this threshold, some type of warning indication is provided to the user/driver. If the monitored voltage drops further to the shut-down threshold, the power manager may either turn off some/all of the connected equipment or cause the vehicle to be started, e.g., with a remote start signal, so that the battery can be recharged with alternator or otherwise.

Typically, the timer and voltage protections operate independently. For example, the system can be implemented so that the voltage protections preempt the timers, i.e., they are triggered even if one or more of the timers is not expired. The voltage protections can also operate even if all timers have expired.

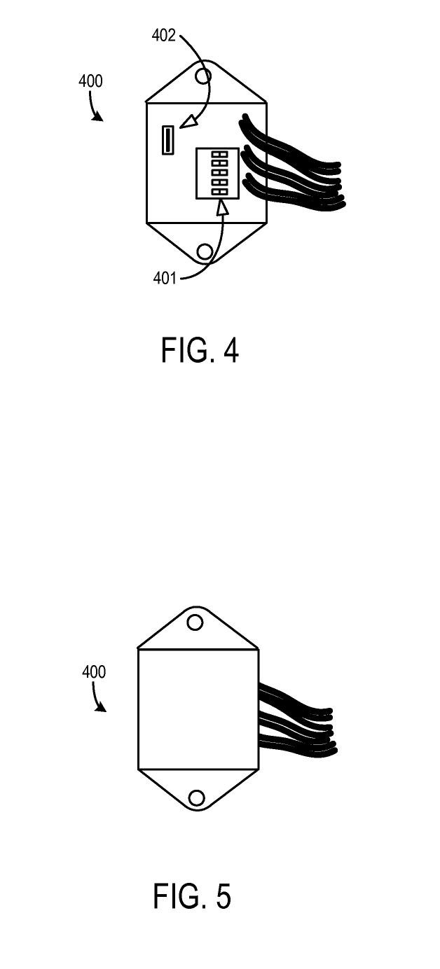

FIGS. 4 and 5 show a form factor of a device 400 that implements the above-described power manager. The device includes various connections to the electrical systems of the vehicle, for example to the battery, ignition, etc. These connections may be considered the “inputs” to the device. The device also includes a connection to supply power to a piece of electrical equipment used with the vehicle, for example an aftermarket radio installed in a law enforcement vehicle. This may be considered as the “output” of the device. The device has one timer and can implement the voltage protections described above.

The device includes a DIP switch interface 401 that the user/driver can operate to selectively enable various functions and control how those functions operate. In the example, there are five switches. One switch enables a mechanism for determining whether the vehicle has been turned on or off without needing to directly access an ignition signal of the vehicle (“ignition-less trigger”). This might be needed where it is difficult or otherwise not feasible to tap into the ignition signal. Another switch enables the voltage protections described above.

The final three switches in the package are used to control the duration of the countdown timer of the device. The table below provides an illustrative example of switch positions and corresponding shutdown time in seconds.

| | Countdown value (in |
|---|---|
| Switch position | seconds) |
| 000 | 1 |
| 001 | 10 |
| 010 | 300 |
| 011 | 900 |
| 100 | 1800 |
| 101 | 3600 |
| 110 | 7200 |
| 111 | 14000 |

The device of FIGS. 4 and 5 also includes a connector 402 for connecting the device to a laptop or other computing device that can run a user interface which allows an operator to further control the power manager and how it operates to protect the vehicle battery.

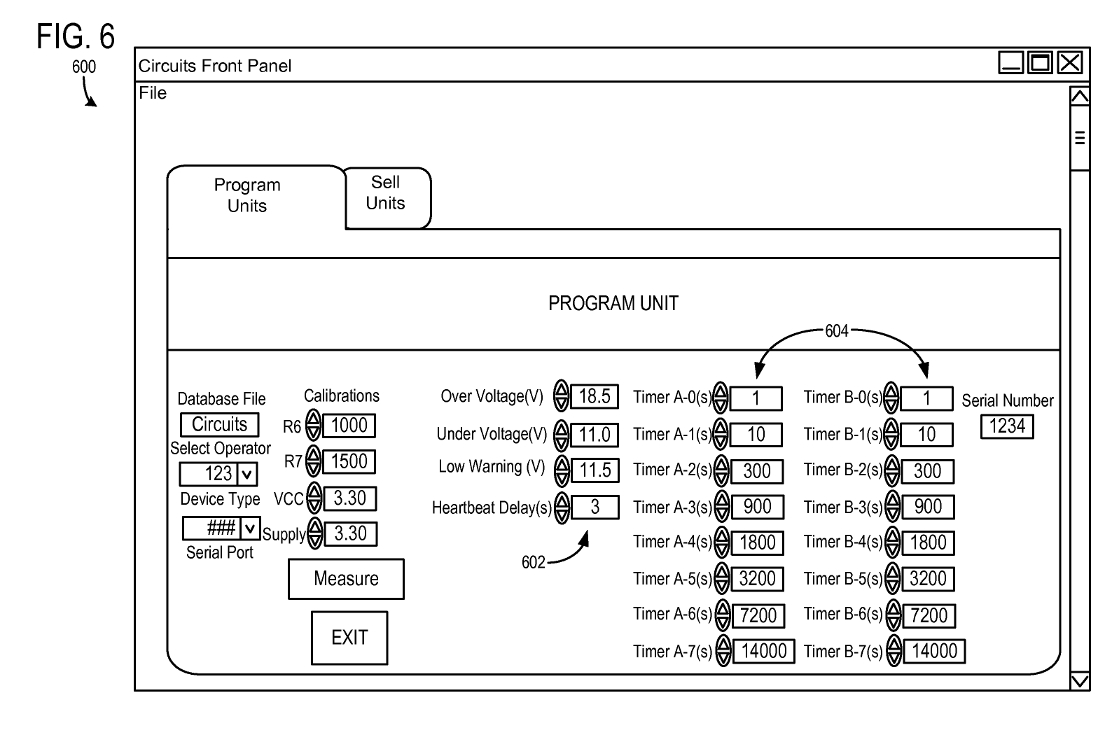

FIG. 6 depicts an example of such an interface 600. It will be appreciated that the interface 600 may be generated via the software utility 50, shown in FIG. 1, and displayed via the computing device 52, shown in FIG. 1. As shown at 602, the interface 600 enables the operator to control how the voltage protections of the power manager operate. The examples shown are for a 12-volt vehicle battery. However, other vehicle battery voltages have been contemplated. One option allows the operator to specify a level for the over-voltage protection, (i.e., the voltage level at which the power manager disconnects electrical equipment to protect it from damage). In the present example, the threshold is being set to 18.5 volts. A second option allows the operator to specify the under-voltage threshold, (i.e., the voltage at which electrical equipment is disconnected from the battery or a remote start signal is sent). This is set in the present example at 11 volts. Another option is a specification of the under-voltage warning threshold described above—set here at 11.5 volts. A “heartbeat delay” option is also included to control the duration between blinks of a low voltage warning light.

The user interface also includes options 604 for programming operation of a DIP switch-controlled timer having a plurality of DIP switches, as described above with reference to FIGS. 4 and 5. The first column shows programming of a first timer (TimerA). The operator specifies the timeout value (e.g., in seconds) for each possible combination of DIP switch values. In this example, when all three DIP switches are off (switch positions are {000}), the timeout value is 1 second. When the switches are set to {101}, the timeout value is 3600 seconds. At {111}, the timeout value is 14000 seconds, and so on. The interface also allows programming of a second timer, in the event that the device being programmed supports two timers.

The user interface can provide other functionality. The software can (i) maintain an electronic serial number that specifies the model of the device being programmed; (ii) maintain board level calibration values; (iii) enable reading of instantaneous voltage levels of the vehicle battery and/or voltages and current draws of the connected electrical equipment.

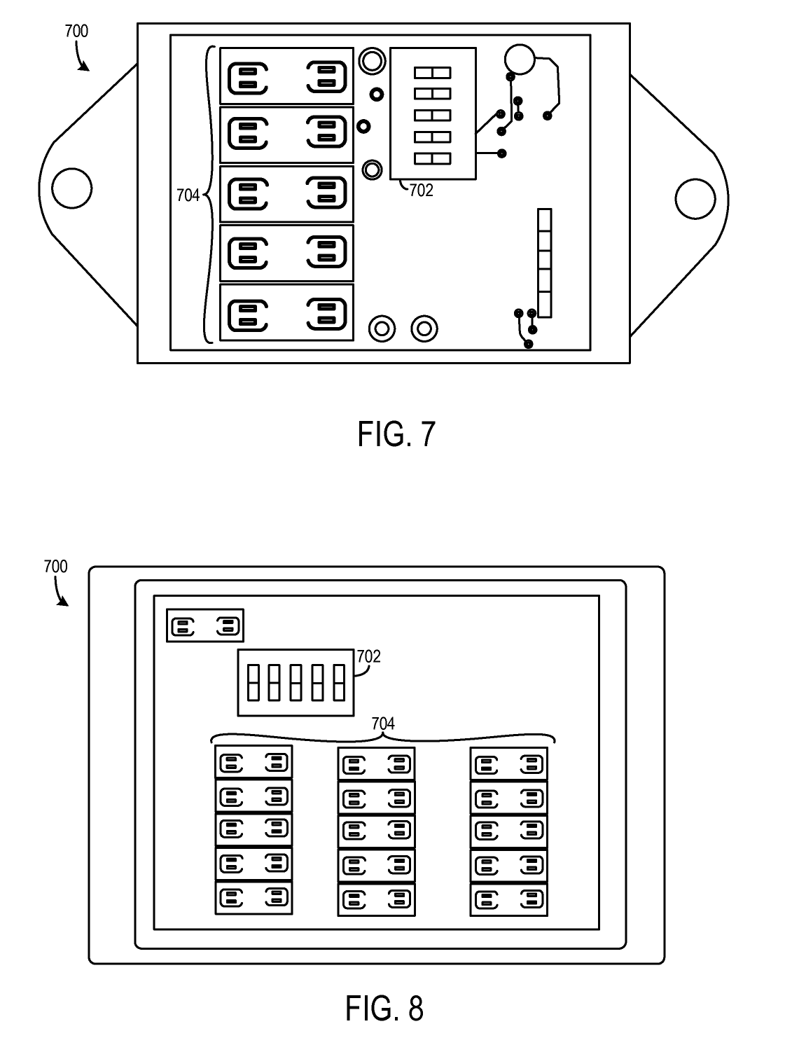

FIGS. 7 and 8 provide other examples of form factors of devices 700 in which the above-described power manager may be employed. As can be seen in the figures, each example includes a DIP switch controller/package 702 that functions as described above. Each example uses only a single timer, though the devices can be easily modified to include two or more timers with additional DIP switches to control the value of the countdown(s). Identical modular connectors may be used on all of the devices for connecting to the electrical systems of the vehicle, for example to allow easy upgrading (e.g., from the device of FIG. 7 to the device of FIG. 8).

FIG. 7 specifically depicts a form factor that supports connection of 5 pieces of equipment to a timer. The device of FIG. 8 supports connection of 15 pieces of equipment to a timer. The connection interfaces providing the connection between the electrical equipment and the timer circuits are shown at 704. It will be appreciated that the power manager may be configured to support connection to an alternate number of pieces of equipment. In some examples, some of the equipment connections may be constant (i.e., not connected to a timer). Such a constant connection might be desirable, to name one example, to maintain enough power to preserve presets on a radio. Such an option can also be included with the other example form factors described herein.

Referring again to FIG. 1, while the vehicle is still running, the timer or timers may be held at their preset values. Also, the system may be optionally set up so that user changes to the settings controlled by the DIP switches are only updateable while the vehicle is running. As described above, the timer or timers begin counting down once the ignition signal is lost. Once the vehicle is restarted, the timers may be reset to the values specified by the DIP switch selections.

It will be appreciated that methods described herein are provided for illustrative purposes only and are not intended to be limiting. Accordingly, it will be appreciated that in some embodiments the methods described herein may include additional or alternative processes, while in some embodiments, the methods described herein may include some processes that may be reordered, performed in parallel or omitted without departing from the scope of the present disclosure. Further, it will be appreciated that the methods described herein may be performed using any suitable software and hardware in addition to or instead of the specific examples described herein. This disclosure also includes all novel and non-obvious combinations and sub-combinations of the above systems and methods, and any and all equivalents thereof.

1. A system for controlling electrical demands on a vehicle battery in a vehicle, comprising:
a power conduit adapted to be coupled between the vehicle battery and one or more pieces of aftermarket electrical equipment deployed within a vehicle having electrical systems powered by the vehicle battery; and
a power manager including:
a timer circuit operatively coupled with the power conduit; and
a hardware selector operable by a user for controlling a timer value of the timer circuit, the system being operative to shut off delivery of electrical power through the power conduit to selected aftermarket electrical equipment in response to an elapsed time exceeding the timer value of the timer circuit.

2. The system of claim 1, wherein the hardware selector is a DIP switch panel.

3. The system of claim 2, wherein the DIP switch panel implements a binary encoding to enable user selection of the timer value.

4. A method of making the system of claim 1, in which a software utility is used to configure timer value ranges that can be selected using the hardware selector.

5. The system of claim 1, further comprising a second timer circuit that is programmable with a second timer value that can be different from the first timer value.

6. The system of claim 1, further comprising:
a sensor for detecting a state of charge of the vehicle battery; and
a remote start actuator operable to cause a remote start of the vehicle in response to the battery state of charge falling below a charge threshold.

7. The system of claim 6, wherein the charge threshold is programmable.

8. The system of claim 1, further comprising a sensor for detecting a state of charge of the vehicle battery, where the power manager is configured to turn off the one or more pieces of aftermarket electrical equipment if the state of charge of the battery falls below a threshold value.

9. The system of claim 1, where the one or more pieces of aftermarket electrical equipment includes one or more of a lighting system, an audio system, a computing system, and a device charger.

10. A method for operating a software utility connected to a system configured to control electrical demands on a vehicle battery, comprising:
configuring timer value ranges that can be selected using a hardware selector operable by a user for controlling timer values of a plurality of timer circuits operatively coupled with a power conduit adapted to be coupled between the vehicle battery and a plurality of pieces of aftermarket electrical equipment deployed within a vehicle having electrical systems powered by the vehicle battery.

11. The method of claim 10, further comprising configuring a charge threshold for a remote start actuator, the remote start actuator operable to cause a remote start of the vehicle in response to a state of charge of the vehicle battery falling below the charge threshold.

12. The method of claim 10, where the plurality of timer circuits are a DIP switch panel including a plurality of DIP switches.

13. A system for controlling electrical demands on a vehicle battery in a vehicle, comprising:
a power conduit adapted to be coupled between the vehicle battery and one or more pieces of aftermarket electrical equipment deployed within a vehicle having electrical systems powered by the vehicle battery;
a power manager including:
a first timer circuit operatively coupled with the power conduit;
a DIP switch panel operable by a user for controlling a timer value of the timer circuit, the system being operative to shut off delivery of electrical power through the power conduit to selected aftermarket electrical equipment in response to an elapsed time exceeding the timer value of the circuit; and
a second timer circuit that is programmable with a second timer value that can be different from the first timer value.

14. The system of claim 13, where the one or more pieces of aftermarket electrical equipment includes one or more of a lighting system, an audio system, a computing system, and a device charger.

15. The system of claim 13, further comprising a sensor for detecting a state of the vehicle battery.

16. The system of claim 15, further comprising a remote start actuator operable to cause a remote start of the vehicle in response to the battery state falling below a charge threshold.

17. The system of claim 15, where the power manager circuit is configured to shut-down power to one or more of the systems when the state of charge of the vehicle battery falls below a charge threshold.

18. The system of claim 16, wherein the charge threshold is programmable.

19. The system of claim 17, where the charge threshold is programmable.

20. The system of claim 13, where the DIP switch panel implements a binary encoding to enable user selection of the timer value.
